(19) United States
(12) Patent Application Publication
(10) Pub. No.: US 2002/0076285 A1
(43) Pub. Date: Jun. 20, 2002

(54) Cutting-processing machine

(76) Inventor: Yoshitaka Tsune, Toyama-ken (JP)

Correspondence Address: Schweitzer Cornman & Gross, 230 Park Avenue, New York, NY, 10169, US

(21) Appl. No.: 09/738,009

(22) Filed: Dec. 15, 2000

(51) Int. Cl. B23Q 1/25

(52) U.S. Cl. 408/37; 408/129; 408/234

(57) ABSTRACT

A cutting-processing machine comprises a vice mechanism for clamping a workpiece to be cutting-processed, a pair of cutting units 6 for cutting-processing both ends of the workpieces, arranged to face one another with the vice mechanism being interposed between both the cutting units and; back-and-forth shifting means 10 for moving back and forth each of the cutting units 6 relative to processing positions for both the ends of the workpiece, comprising a guide member 12 for controlling the movement of the cutting unit, a ball-combined feed screw type feed mechanism 13 for moving the cutting unit reciprocally along the guide member, and a servomotor 15 for setting a feed screw bar 14 of the feed mechanism in rotational motion, wherein a contact projection 32 is provided on a front side of the cutting unit 6, and a stopper 33 is arranged to retractably jut over a moving passage of the cutting unit so that, when the cutting unit is caused to advance from a backward position, the contact projection 32 comes into contact with the stopper 33, and thereby the cutting unit 6 stops at/near a position where the cutting unit is about to start processing to the workpiece, and such a stop position of the cutting unit is adopted as a reference point of the feed quantity of the cutting unit.

### INDUSTRIAL FIELD OF APPLICATION

The present invention relates to a cutting-processing machine adapted to cutting-process the ends of hollow or solid workpieces of a beforehand cut-off predetermined length while clamped in the vise mechanism.

### BACKGROUND AND SUMMARY OF THE INVENTION

The conventional cutting-processing machine has a rotational cutting unit of which the back-and-forth shifting is completed by means of a hydraulic cylinder. On cutting-processing the workpieces, the cutting unit is caused to move reciprocally between the foremost position for processing the ends of workpieces and the rearmost positions in a stroke corresponding to a moving distance of the cutting unit. However, the foremost and rearmost positions of the cutting unit are established by setting a stopper for each of them. This means that, every time the workpieces of different lengths are used, it is required to change the moving distance of the cutting unit and also change and adjust the setting position of the stopper for the foremost position. Thus, such working of adjustment is troublesome. In addition, the using of the hydraulic cylinder as a shifting means of the cutting unit brings up a problem that the cutting unit cannot take a sufficiently great distance length of effective stroke.

Besides, there has been conventionally a machine tool having a rotational cutting unit of which the back-and-forth shifting is completed with a feed screw type feed mechanism comprising a feet screw bar and a nut member attached thereto. In a case where many workpieces are cutting-processed using the machine tool, the feed screw bar is thermally expanded and made longer by an increased temperature due to friction with the nut member, in which an actual feed quantity of the cutting unit is varied from a preset feed quantity of the cutting unit. This brings up a problem that errors in feeding the cutting unit occur and causes the reduction of the processing precision.

To overcome the above-mentioned problems, it is an objective of the present invention to provide a cutting-processing machine which can keep up with the change in the moving distance of a rotational cutting unit when using different lengths of workpiece and allows the cutting unit to take an effective stroke as long as possible.

It is a second objective of the invention to provide a cutting-processing machine which can prevent the occurrence of errors in feeding the cutting unit due to the thermal expansion of the feed screw bar of the feed screw type feed mechanism.

The further objectives will become apparent from the following detailed description of the embodiments.

With the above object in view, the present invention provide a cutting-processing machine comprises a vice mechanism for clamping a hollow/solid workpiece to be cutting-processed, a pair of cutting units for cutting-processing both ends of the workpieces, arranged to face one another with the vice mechanism being interposed between both the cutting units; and back-and-forth shifting means for moving back and forth each of the cutting units relative to processing positions for both the ends of the workpiece, comprising a guide member for controlling the movement of the cutting unit, a ball-combined feed screw type feed mechanism for moving the cutting unit reciprocally along the guide member, and a servomotor for setting a feed screw bar of the feed mechanism in rotational motion.

### BRIEF DESCRIPTION OF THE DRAWINGS

FIG. 1 is a plan view showing one embodiment of a processing machine for cutting-processing both the ends of workpieces, to which the present invention is applied;

FIG. 2 is an enlarged plan view showing essential parts of the embodiment of FIG. 1;

FIG. 3 is an elevational front view of section taken along the line III-III of FIG. 2;

FIG. 4 is an elevational side view of a rotational cutting unit;

FIG. 5 is a front view of the rotational cutting unit;

FIG. 6 is a plan view taken along the line VI-VI of FIG. 4; and

FIG. 7 includes three diagrams of \mathring{1} \mathring{2} \mathring{3} for illustration of operations of a feed-error prevention apparatus in connection with bevelling-processes of the workpieces by the processing machine.

### DETAILED DESCRIPTION OF THE PREFERRED EMBODIMENTS

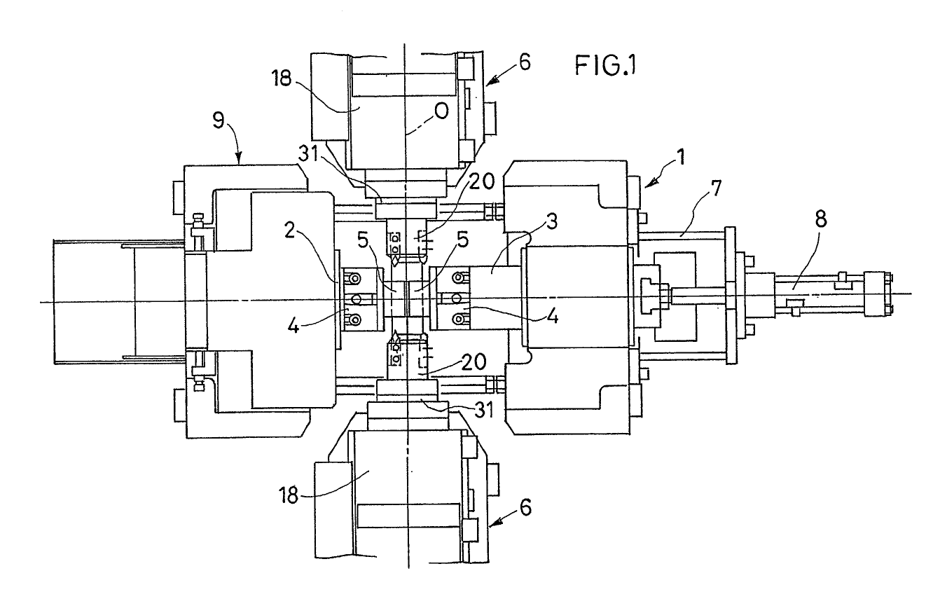

In FIGS. 1, 2 and 3, the numeral 1 designates a vice mechanism which comprises a fixed vice mount 2 and a movable vice mount 3 separately bilaterally arranged on a line in a manner to face to one another relative to a crossing line O. A couple of vice jaw 5, 5, which are of a round half body shaped like two divided circular cylinder, each are mounted on both the vice mounts 2, 3, by way of an attachment 4. Each of hollow workpieces W (or solid workpieces) to be processed is clamped from the bilateral outsides by both the vice jaws 5, 5 of round halves.

When clamping the workpiece, both the vice jaws 5, 5 of round halves have a clearance S formed between the opposing faces of the both the vice jaws. As understood particularly from FIG. 1, a pair of rotational cutting units 6, 6 are so arranged as to face to one another along the crossing line O across a line of the arranged vice jaws 5, 5 of vice mechanism 1 with the vice jaws 5, 5 being interposed between a pair of the cutting units 6, 6, and are so constructed as to process both ends of the workpiece W clamped in the vice mechanism 1, and are adapted to move on the extension of the extended axis O of the workpiece W.

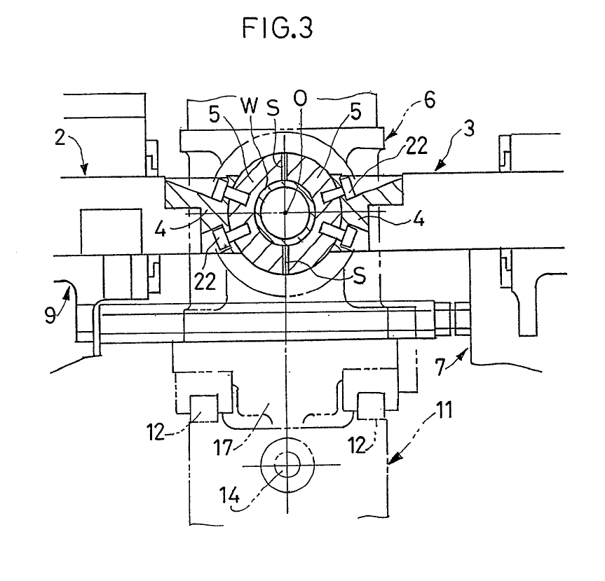

The movable vice mount 3 of the vice mechanism 1 is horizontally movably supported, as shown in FIGS. 1 and 3, on a supporting frame 7, and is associated with a hydraulic cylinder 8 mounted on the support frame 7 so as to move closer to and away from the fixed vice mount 2 by the pushing and pulling operations of the hydraulic cylinder 8. The fixed vice mount 2 is also supported on a support frame 9, but is so formed as to be adjustably moved closer to and away from the line O, i.e. a rotational axis of the rotational cutting units 6 in order that a central line of the workpiece to be clamped by both the vice jaws 5, 5 meet the rotational axis O.

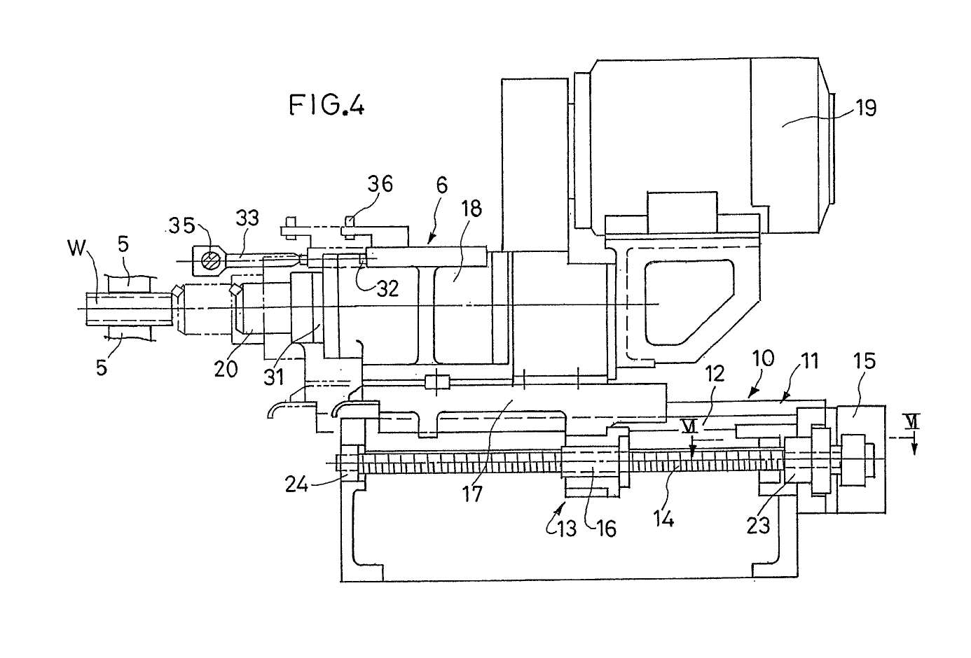

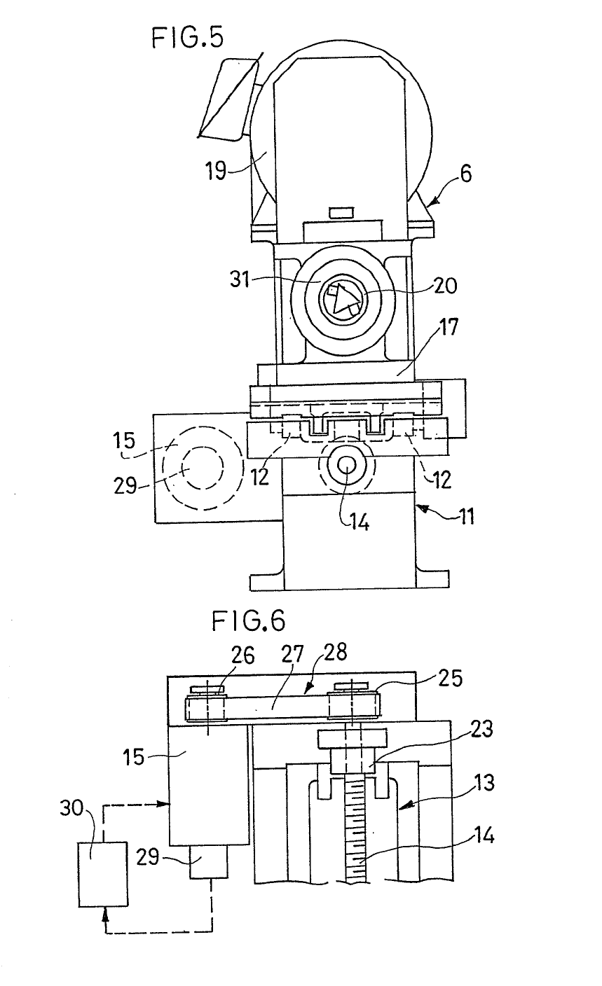

As shown in FIGS. 4 and 5, a back-and forth shifting apparatus 10 causes each of the rotational cutting units 6, 6 to move reciprocally on a base frame 11, i.e. advance to a processing position for ends of the workpieces and retract along the extended axis of the workpiece which is clamped by both the vice jaws 5, 5 of the vice mechanism 1. The back-and forth shifting means 10 is set on the base frame 11, and comprises guide members 12 for controlling the movement of the rotational cutting unit 6, a ball-combined feed screw type feed mechanism 13 for moving the rotational cutting unit 6 reciprocally along the guide members 12, and a servomotor 15 for setting a feed screw bar 14 of the feed mechanism 13 in rotational motion.

As shown in FIG. 4, the feed screw bar 14 of the feed mechanism 13 has both ends supported on bearings 23, 24 which are provided on ends of the base frame 11. A nut member 16 is fitted around the feed screw bar 14, and is fixed on a movable base 17 of the rotational cutting unit 6. The feed screw bar 14 is interconnected with the servomotor 15, as shown in FIG. 6, by way of transmission means 28 comprising a timing belt 27 and timing pulleys 25, 26. The servomotor 15 is controlled by a controller 30, and is provided coaxially with a rotary encoder 29 (detector) for computing a feed quantity of the rotational cutting unit 6 based on a rotation quantity of the servomotor 15.

Each of the rotational cutting units 6 has a rotary main shaft 31, as shown in FIG. 4, which is accommodated by a unit casing 18 and driven by a motor 19. In a free end of the rotary main shaft 31, an end processing tool, such as a chamfering or bevelling tool 20, is detachably mounted for processing the ends of workpieces W.

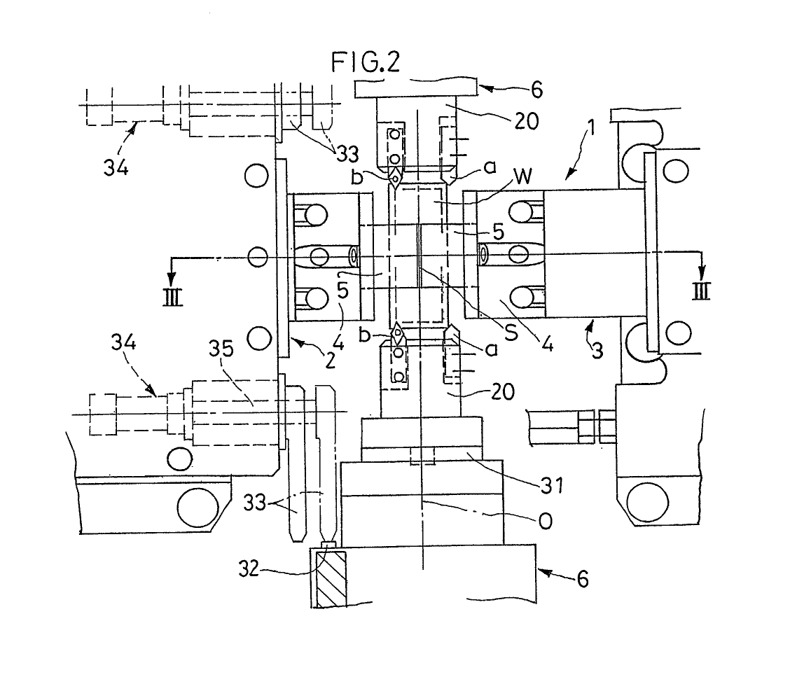

In the use of the end processing machine so constructed as described above, the first step is to clamp one workpiece to be processed, in a predetermined position in the vice mechanism 1. Particularly, there are used a couple of the vice jaws 5, 5 of round halves of size corresponding to a diameter of the workpiece to be processed, which vice jaws 5, 5 are fixed on the attachments 4, 4 with bolts 22 (FIG. 3), whereas the attachments 4, 4 are set on the fixed vice mount 2 and the movable vice mount 3. Then, by actuating the hydraulic cylinder 8 in an active stretching state, the movable vise mount 3 is caused to move closer to the fixed vice mount 2, so that the workpiece W is clamped in a condition as shown in FIGS. 2 and 3 by both the vice jaws 5, 5. In the next step, both the opposing rotational cutting units 6, 6 are caused to advance by the back-and-forth shifting apparatus 10 toward the processing positions for processing the opposite ends of the workpiece W, and therein perform the bevelling processing to both the ends of the workpiece W. In the rotary main shaft 31 of each of both the rotational cutting units 6, 6, there is mounted the bevelling tool 20 which has a cutter a for bevelling an outer peripheral surface of the hollow workpiece and another cutter b for bevelling an inner peripheral surface.

In the cutting-processing machine, the back-and-forth shifting apparatus 10 comprises, as described above, the guide members 12 for controlling the movement of the rotational cutting unit 6, the ball-combined feed screw type feed mechanism 13 for moving the rotational cutting unit 6 reciprocally along the guide members 12, and the servomotor 15 for setting the feed screw bar 14 of the feed mechanism 13 in rotational motion, so that the proper control of the servomotor 15 by the controller 30 can set the cutting unit 6 to a desired moving stroke St. Accordingly, when a different length of the other workpiece is used with the need of a different feed quantity of the cutting unit, it is facile to set a renewal moving distance (moving stroke) of the cutting unit accompanied by the change in the length of workpieces. That is, when the other workpiece different in length is used, the value of the renewal length (or renewal feed quantity) is inputted with numeric keys on a control panel, so the cutting unit 6 can be set to a renewal moving stroke.

Further, according to the back-and-forth shifting apparatus 10 having the ball-combined feed screw type feed mechanism 13, as compared with the prior art back-and-forth shifting apparatus using a hydraulic cylinder, the cutting unit can take a greater length of effective stroke.

Next, a detailed description is given about a feeding-error prevention apparatus mechanism, built in the processing machine of the invention, for preventing the occurrence of errors in feeding the cutting unit due to the thermal expansion in the ball-combined feed screw type feed mechanism 13 of the back-and-forth shifting apparatus 10.

The feeding-error prevention apparatus comprises, as shown in FIGS. 2 and 4, a contact projection 32 provided on a front side of the rotational cutting units 6, and a stopper 33 arranged to retractably jut over a desired position of a moving passage of the cutting units 6 from the fixed vice mount 2 so that, when the rotational cutting unit 6 is caused to advance from a backward position, the contact projection 32 comes into contacts with the stopper 33, and thereby the rotational cutting unit 6 stops at/near a position where the cutting unit 6 is about to start processing to the workpiece. The feeding-error prevention mechanism is adapted to adopt such a stop position of the cutting unit 6 as a reference point of the feed quantity of the rotational cutting unit 6. The feed quantity is detected, i.e. computed by the rotary encoder 29. The reference point is used as a feed starting point (zero point) of the rotational cutting unit 6 to the workpiece.

In the feeding-error prevention apparatus, the reference point is based on the position where the cutting unit 6 is stopped by the contact of stopper 33 with the contact projection of the cutting unit, and the feed starting point is determined from the reference point. The feed start point is the position where the bevelling tool 20 of the cutting unit 6 is about to start processing to the workpiece. Thus, even if there is a likelihood that the feed screw bar 14 of the feed mechanism 13 is made longer by thermal expansion due to friction with the nut member 16, the feed quantity of the rotational cutting unit 6 from the feed starting point is relatively very small as compared with the full length of the feed screw bar 14, so that there is little influence of thermal expansion and no feeding error occurs.

Contrary to the above-described feed mechanism, the prior art feed screw type feed mechanism used in conventional machine tools has a rotational cutting unit of which a reference point (zero point) of feed quantity to be computed by the encoder is set to the rearmost position of the cutting unit which is retracted on one end of the feed screw. Thus, on processing the workpiece, the feeding of the cutting unit to the workpiece is started from the condition where the cutting unit is positioned on the middle of the feed screw, so that, when the feed screw bar of the feed mechanism is made longer by thermal expansion, the feed quantity of the cutting unit differs from that under a normal temperature, and errors in feeding are much likely to occur.

The feeding-error prevention apparatus of the invention features the stopper 33 which is brought into contact with the contact projection 32 of the cutting unit 6. As shown particularly in FIG. 2, the stopper 33 is associated with an actuator 34, which is fitted in the inside of the fixed vice mount 2 of the vice mechanism 1, so as to retractably jut over the passage of the cutting unit 6 between an operative position (, shown in solid lines in FIG. 2) and an inactive position (, shown in two-dots-lines in FIG. 2). The actuator 34 has an actuating shaft 35 extending across the moving passage, while the stopper 33 is connected integrally with a free end of the actuating shaft 35 so as to extend along the passage. The pushing operation of the actuator 34 causes the stopper 33 to advance to the operative position over the passage, whereas the pulling operation of the actuator 34 causes the stopper 33 to retract to the inactive position.

As shown in FIG. 4, the contact projection 32 on each of the rotational cutting unit 6 is arranged on the upper and front side of the unit casing 18. Further, ahead of the contact projection 32 and at a slightly upper level than it, there is provided a sensor 36 from the unit casing 18, for detecting the free end of the stopper 33 before the contact projection 32 of the cutting unit 6 comes into contact with the stopper 33. The sensor 36 issues detection signals to decelerate the servomotor 15.

After coming into contact with the contact projection 32 of the cutting unit 6, the stopper 33 is made to retract in the inactive position from the active position over the moving passage of the cutting unit 6. However, under this situation, it is difficult to cause the stopper 33 to retract in a condition that the stopper 33 stays in contact with the contact projection 32 of the cutting unit 6. For this reason, after the contact projection 32 having contact with the stopper 33, the cutting unit 6 is shifted backwardly by a predetermined distance, and then moved again forwardly therefrom to the workpiece to be cut.

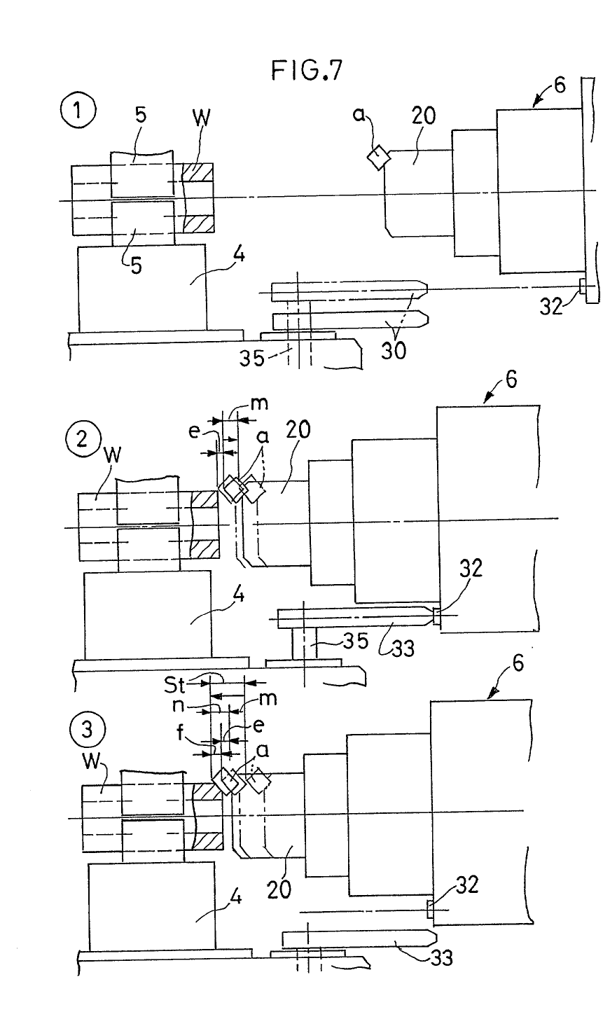

Referring to FIG. 7, the operations of the feeding-error prevention apparatus is described together with the operations of the cutting-processing machine for ends of the workpiece. On performing the bevelling processing of the workpiece W by means of the rotational cutting unit, the stopper 33 is pushed out from the inactive position (as shown in the diagram \mathring{1} of FIG. 7 with solid lines) to the active position (shown with two-dots lines in the same diagram) so as to jut over the moving passage of the cutting unit. In the other hand, the cutting unit 6 is caused to move toward the workpiece from the backward position until the contact projection 32 of the cutting unit 6 comes into contact with the pushed-out stopper 33 and the cutting unit 6 stops as shown in the diagram \mathring{2} of FIG. 7.

The location of the cutting unit 6 at the time of contact with stopper 32 is preferably set so that there is a narrow space e, as shown in \mathring{2} of FIG. 7, between the cutter a of the bevelling tool 20 and the end of the workpiece W. That is, it is preferable to set the stopper 33 so that the rotational cutting unit 6 stops near a position where the cutting unit 6 is about to start processing to the workpiece.

Just before the contact projection 32 on the cutting unit 6 comes into contact with the stopper 33, the sensor 36 on the cutting unit 6 detect the presence of the stopper 33 and issues the detection signals to decelerate the servomotor 15. Thereby, the shock of the contact projection 32 against the stopper 33 can be reduced, and at the same time the cutting unit 6 can be surely stopped at the position where the contact projection 32 comes into contact with the stopper 33.

Based on the position where the cutting unit 6 is stopped by the contact of stopper 33 with the contact projection of the cutting unit, the reference point is established for the feed quantity of the cutting unit 6 to be computed by the rotary encoder 29, and the feed starting point is determined from the reference point. Thereafter, the stopper 33 is made to retract to the inactive position. However, in this step, considering that it is difficult to retract the stopper 33 in a condition that the stopper 33 stays in close contact with the contact projection 32 of the cutting unit 6, the cutting unit 6 is shifted backwardly, as shown in the diagram \mathring{2} of FIG. 7 with a right-directional arrow, by a slight distance m from the stopping position, and then the stopper 33 is retracted from the active position as shown in \mathring{2} of FIG. 7 with the solid lines, to the inactive position as shown in \mathring{3} of FIG. 7.

In this manner, the rotational cutting unit 6 is set in a forward movement to the workpiece from the backwardly shifted position (actually starting position) as mentioned above, and then performs the bevelling processing to the workpiece. Sequentially, a series of the steps are repeated. The moving stroke from the backwardly shifted position to the of finishing the bevelling processing is, as understood from \mathring{3} of FIG. 7, a sum total of the three values m, e and f, where the value m is the backwardly shifted distance m in which the cutting unit 6 is shifted backwardly after having contact with the stopper 33, the value e is the forward moving distance e of the unit 6 in which the cutting unit 6 moves forwardly from the position of the unit 6 where the contact projection 32 has contact with stopper 33 to the position of the unit 6 where the cutter a of the bevelling tool 20 has contact with the workpiece W, and the value f is the net feed quantity for the workpiece W equivalent to the moving distance of the unit 6 from the time when the cutter a of the bevelling tool 20 starts to cutting-process workpiece W to the time when the cutter finishes the cutting-process of the workpiece W. Therefore, the substantial moving distance n from the reference point (position) is a sum total of e and f.

Based on the above-described relations, when the net feed quantity f to the workpiece W is 2 mm, the backwardly shifted distance m is enough to be about 3 mm while the forward moving distance e is enough to be about 5 mm, so that the moving stroke of the cutting unit St, i.e. the total feed quantity is about 10 mm. Accordingly, the substantial feed quantity of the cutting unit 6 from the reference point (position) is 7 mm. With this small degree of feed quantity, the bevelling processing can be completed. Therefore, even if the feed screw 14 of the feed mechanism 13 in the back-and-forth shifting apparatus 10 of the cutting unit 6 is thermally expanded and made longer by an increased temperature due to friction with the nut member 16, the feed quantity of the rotational cutting unit 6 from the feed starting point is relatively very small as compared with the feed screw bar 14 of about 200-400 mm in the full length, so that there is little influence of thermal expansion and no little feed error occurs.

A series of the steps are controlled by the controller 30, which is of a programmable controller type, set by a prepared program. The above-indicated values of the moving distances e, f, m, n and the frequency of feed and the other can be set with a control panel (not shown) of the controller 30.

The feeding-error prevention apparatus in the above-described embodiment is devised in connection with the processing machine for both ends of workpieces, but can be applied to other cutting-processing machines. However, the ends cutting-processing machine is adapted to perform the bevelling processing for faces and ends of workpieces while feeding the cutting unit to the workpiece, and therefore needs to fill the requirement that the feed quantity to the workpiece is smaller and the precision of cutting-processing is higher as compared to that of other cutting-processing machines. Further, in the end processing machine, there is a likelihood that the feed screw of the feed mechanism is easy to expand due to frictional heat. Therefore, with end to lessen the influence of thermal expansion of the feed screw and thereby prevent the occurrence of errors in feeding, it is very effective to apply the feeding-error prevention apparatus to the end processing machine.

In the above-described embodiment, there is adopted the so-called ball-combined feed screw type feed mechanism which includes steel balls interposed between the feed screw and the nut member. However, it is possible to apply the feeding-error prevention apparatus to a normal feed screw type feed mechanism which merely comprises the feed screw and the nut member.

According to the invention, back-and-forth shifting means of each of the cutting units comprises a guide member for controlling the movement of the cutting unit, a ball-combined feed screw type feed mechanism for moving the cutting unit reciprocally along the guide members, and a servomotor for setting a feed screw bar of the feed mechanism in rotational motion. As a result of it, when a different length of the other workpiece is used, it is facile to set a renewal moving distance (moving stroke) of the cutting unit accompanied by the change in the length of workpieces, without making a troublesome working as in the prior art. That is, when the other workpiece different in length is used, the value of the renewal length (or renewal feed quantity) is inputted with numeric keys on a control panel, so the cutting unit can be set to a renewal moving stroke.

Further, according to the invention, in the feeding-error prevention apparatus, the reference point is based on the position where the cutting unit is stopped by the contact of stopper with the contact projection of the cutting unit, and the feed starting point is determined from the reference point. The feed start point is the position where the bevelling tool of the cutting unit is about to start processing to the workpiece. Thus, even if there is a likelihood that the feed screw bar of the feed mechanism is made longer by thermal expansion due to friction with the nut member, the feed quantity of the rotational cutting unit from the feed starting point is relatively very small as compared with the full length of the feed screw bar, so that there is little influence of thermal expansion and no feeding error occurs. In this manner, the feeding-error prevention apparatus can prevent the errors in feeding very simply and easily.

Contrary to the above-described feed mechanism, the prior art feed screw type feed mechanism used in conventional machine tools has a rotational cutting unit of which a reference point (zero point) of feed quantity to be computed by the encoder is set to the rearmost position of the cutting unit which is retracted on one end of the feed screw. As a result, on processing the workpiece, the feeding of the cutting unit to the workpiece is started from the condition where the cutting unit is positioned on the middle of the feed screw, so that, when the feed screw bar of the feed mechanism is made longer by thermal expansion, the feed quantity of the cutting unit differs from that under a normal temperature, and errors in feeding are much likely to occur.

Further, according to the invention, the cutting unit is so constructed that, after having contact with the stopper, the contact projection is shifted backwardly by a predetermined distance, and then moved again forwardly therefrom to the workpiece to be cut. As a result, the stopper, which has once came into contact with the contact projection of the cutting unit, can be easily retracted out of the moving passage of the cutting unit.

Further, according to the invention, the stopper is associated with an actuator set on a stationary side, so as to retractably jut over the passage of the cutting unit between an operative position and an inactive position. As a result, the mechanism for jutting and retracting the stopper can be simplified and easy to manufacture.

Further, according to the invention, a sensor is provided on and from the cutting unit, for detecting the stopper before the contact projection on the cutting unit comes into contact with the stopper, and the sensor is adapted to issue detection signals to decelerate the servomotor. As a result, just before the contact projection on the cutting unit comes into contact with the stopper, the sensor on the cutting unit detect the presence of the stopper and issues the detection signals to decelerate the servomotor. Thereby, the shock of the contact projection against the stopper can be reduced, and at the same time the cutting unit can be surely stopped at the position where the contact projection comes into contact with the stopper.

What is claimed is:

1. A cutting-processing machine comprising:
a vice mechanism for clamping a hollow/solid workpiece to be cutting-processed,
a pair of cutting units for cutting-processing both ends of the workpieces, arranged to face one another with the vice mechanism being interposed between both the cutting units and;
back-and-forth shifting means for moving back and forth each of the cutting units relative to processing positions for both the ends of the workpiece, comprising a guide member for controlling the movement of the cutting unit, a ball-combined feed screw type feed mechanism for moving the cutting unit reciprocally along the guide member, and a servomotor for setting a feed screw bar of the feed mechanism in rotational motion.

2. A cutting-processing machine comprising
a cutting unit for cutting-processing a workpiece set in a fixed position,
a feed screw type feed mechanism for move forth the cutting unit toward the workpiece, the feed mechanism being provided with a detector for computing a feed quantity of the cutting unit,
wherein
a contact projection is provided on a front side of the cutting unit, and a stopper is arranged to retractably jut over a desired position of a moving passage of the cutting unit so that, when the cutting unit is caused to advance from a backward position, the contact projection comes into contact with the stopper, and thereby the cutting unit stops at/near a position where the cutting unit is about to start processing to the workpiece, and such a stop position of the cutting unit is adopted as a reference point of the feed quantity of the cutting unit to be computed by the detector.

3. The cutting-processing machine as defined in claim 2, wherein the cutting unit is so constructed that, after having contact with the stopper, the contact projection is shifted backwardly by a predetermined distance, and then moved again forwardly therefrom to the workpiece to be cut.

4. The cutting-processing machine as defined in claim 2, wherein the stopper is associated with an actuator set on a stationary side, so as to retractably jut over the passage of the cutting unit between an operative position and an inactive position.

5. The cutting-processing machine as defined in claim 2, wherein a sensor is provided on and from the cutting unit, for detecting the stopper before the contact projection on the cutting unit comes into contact with the stopper, and the sensor is adapted to issue detection signals to decelerate the servomotor.
